(19) United States
(12) Patent Application Publication
(10) Pub. No.: US 2017/0336235 A1
(43) Pub. Date: Nov. 23, 2017

(54) WATER MONITORING SYSTEM WITH ADJUSTABLE AERATOR

(71) Applicant: The Archer School for Girls, Brentwood, CA (US)

(72) Inventors: Marcela Riddick, Los Angeles, CA (US); Rachel Erickson, Los Angeles, CA (US); Alexandra Feldman, Los Angeles, CA (US); Claire Germano, Los Angeles, CA (US); Uma Halsted, Los Angeles, CA (US); Iman Hussain, Los Angeles, CA (US); Aviva Intveld, Los Angeles, CA (US); Ruby Krull, Los Angeles, CA (US); Iman Mohammed, Los Angeles, CA (US); Isabella Moncada, Los Angeles, CA (US); Annie Moore, Los Angeles, CA (US); Carina Oriel, Los Angeles, CA (US); Elyse Pollack, Los Angeles, CA (US); Annabelle Robertson, Los Angeles, CA (US); Ava Rothenberg, Los Angeles, CA (US); Isabella Simanowitz, Los Angeles, CA (US); Ciel Torres, Los Angeles, CA (US); Maya Wernick, Los Angeles, CA (US); Isabelle Wilson, Los Angeles, CA (US); Lola Wolf, Los Angeles, CA (US); Claire Zeller, Los Angeles, CA (US)

(21) Appl. No.: 15/602,014

(22) Filed: May 22, 2017

Related U.S. Application Data
(60) Provisional application No. 62/339,865, filed on May 21, 2016.

(51) Int. Cl. G01F 15/075; G05D 7/06; G01F 1/10; F03B 17/06; E03C 1/084; H02K 7/18; E03C 1/05

(52) U.S. Cl. CPC G01F 15/075; H02K 7/1823; G05D 7/0641; E03C 1/055; F03B 17/061; E03C 1/084; G01F 1/10

(57) ABSTRACT

A compact faucet attachment with an adjustable aerator that monitors water usage and encourages positive water-saving behaviors. The attachment replaces an existing faucet aerator and allows users to change the pressure and pattern of the water flowing through their faucet. It has a thread adapter to ensure that it fits most common faucets. Additionally, on a display screen, numerical data and icons show users statistics regarding how much water they use compared to a daily recommended amount. The device's battery is rechargeable.

### CROSS-REFERENCE TO RELATED APPLICATIONS

This application claims priority to and the benefit of provisional patent application No. 62/339,865, entitled “Water Monitoring System with Adjustable Aerator”, filed in the United States Patent and Trademark Office on May 21, 2016, the entire content of which is incorporated herein by reference.

### BACKGROUND

### Field

Aspects of the present disclosure relate generally to water conservation devices, and more particularly, to a water monitoring system with adjustable aerator.

### Background

Drought is a problem that affects many areas around the world. Even in areas of the world where drought is not common, maximizing use of water is important for such reasons as increase in population and use in agriculture. Currently there are many devices that help reduce water use directly, such as low-flush toilets or low-flow shower heads. However, many of these device do not actually change consumer attitudes and behaviors about overall water use. In fact, in some cases consumer behavior may be changed for the worse. For example, users of low-flush toilets may flush the toilet multiple times, resulting in more water actually being wasted. In another example, users of low-flow shower heads may take longer showers, which also results in a net water waste.

Conventional water saving devices may also cause frustration for consumers, thereby reinforcing negative attitudes towards conservation of this precious resource. For example, faucet attachments that aim to conserve water use manifest themselves as low-flow faucet heads. In kitchens, the low-flow rates of these faucet heads make filling of large containers such as pots or pitchers extremely time consuming Thus, the user may simply leave the kitchen while leaving the faucet running, which results in water being wasted when the water overflows. Even when water does not overflow the container, water is similarly wasted when the user does not come back to the faucet in time to turn off the faucet when the container is filled to a desired level because the user then will pour out the excess water. Furthermore, some users may elect to not install water saving devices or even remove existing water saving components such as flow restrictors included in many faucets and showerheads to avoid the perceived nuisance related to limited water flow.

Consequently, a device that can save water as well as change consumer attitudes and behavior long-term is desirable.

### SUMMARY

The following presents a simplified summary of one or more aspects of the disclosed water monitoring system with adjustable aerator in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In accordance with various aspects of the disclosure, the water monitoring system with adjustable aerator is implemented as a water-flow adjustment device that includes a compact digital water meter with an adjustable water dispensing device. The adjustable water dispensing device may include flow rate settings configured to allow a flow rate and/or pattern of water dispensed through the adjustable water dispensing device to be changed.

The water-flow adjustment device may also include a display to provide users information about how much water has been used as compared to a baseline consumption (amount, rate, etc.), including a notification when a particular threshold has been exceed. Electronics in the water-flow adjustment device may be used to control the adjustable water dispensing device.

The water-flow adjustment device may be attached to an existing faucet in place of the aerator of the existing faucet. Thus, the water-flow adjustment device may act as a replacement aerator. The water-flow adjustment device may also be configured to replace an existing faucet, where the water-flow adjustment device would include one or more valves to control water from the water supply.

These and other aspects of the disclosure will become more fully understood upon a review of the detailed description, which follows.

### BRIEF DESCRIPTION OF THE DRAWINGS

These and other sample aspects of the disclosure will be described in the detailed description that follow, and in the accompanying drawings.

FIG. 1 is a diagram conceptually illustrating an example implementation of a water monitoring system with adjustable aerator.

FIG. 2 is an exploded parts diagram illustrating a water monitoring and control device configured in accordance with various aspects of the water monitoring system with adjustable aerator of FIG. 1.

FIG. 3 is a block diagram of a water monitoring and control system configured in accordance with various aspects of the water monitoring system with adjustable aerator of FIG. 1.

FIG. 4 is a block diagram of a network in which the water monitoring system with adjustable aerator of FIG. 1 may be used.

FIG. 5 is a block diagram of a direct connection of water monitoring and control system in which the water monitoring system with adjustable aerator of FIG. 1 may be used.

FIG. 6 is an exploded parts diagram of another water monitoring and control device configured in accordance with various aspects of the water monitoring system with adjustable aerator of FIG. 1.

FIG. 7 is a flow diagram describing an operation of the water monitoring system with adjustable aerator of FIG. 1.

In accordance with common practice, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

The detailed description set forth below in connection with the appended drawings is intended as a description of various configurations of a water monitoring system with adjustable aerator and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Conventionally, faucet attachments that aim to conserve water manifest themselves as low-flow faucet heads and aerators. However, because they are simple aerators, these devices have a fixed flow setting or, at best, an on/off setting. Other apparatuses measure the volume of water flowing through a faucet, but do not adjust the flow of the water. None of the aforementioned devices provides a display that has the ability to compare water use through the faucet, such as to a recommended baseline.

The various concepts presented throughout this disclosure may be implemented across a broad variety of water dispensing devices. By way of example and not limitation, a water-flow adjustment device implemented as a water-saving faucet attachment for a kitchen faucet is used to describe various aspects of the disclosure. Thus, the water-saving faucet attachment may replace existing an aerator on the kitchen faucet. However, it should be apparent that the various aspects of the disclosure may be implemented in other types of water dispensing devices such as shower heads, bath faucets, and sprinklers. The water-flow adjustment device may be used to encourage water saving directly at the source of where the water is dispensed.

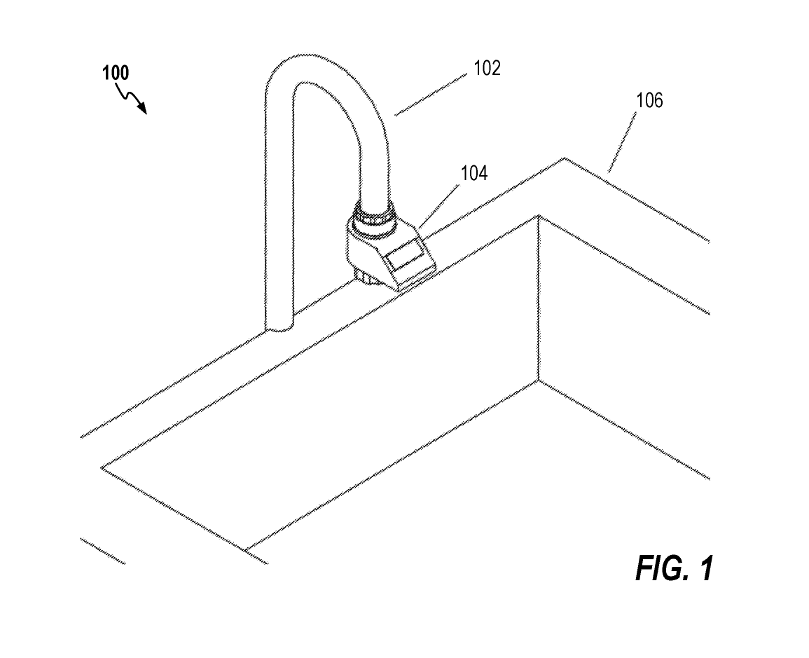

Referring now to FIG. 1, as an illustrative example without limitation, various aspects of the present disclosure for the water monitoring system with adjustable aerator are first illustrated with reference to a water monitoring and control device 104 that is mounted to a supply pipe 102 of a sink 106. As further described herein, the water monitoring and control device 104 is a water-flow adjustment device that may include a digital water meter, a way to control dispensing a set amount of water per period of time, and a different spray pattern for each use. The water monitoring and control device 104 may replace an aerator of an existing faucet of the supply pipe 102.

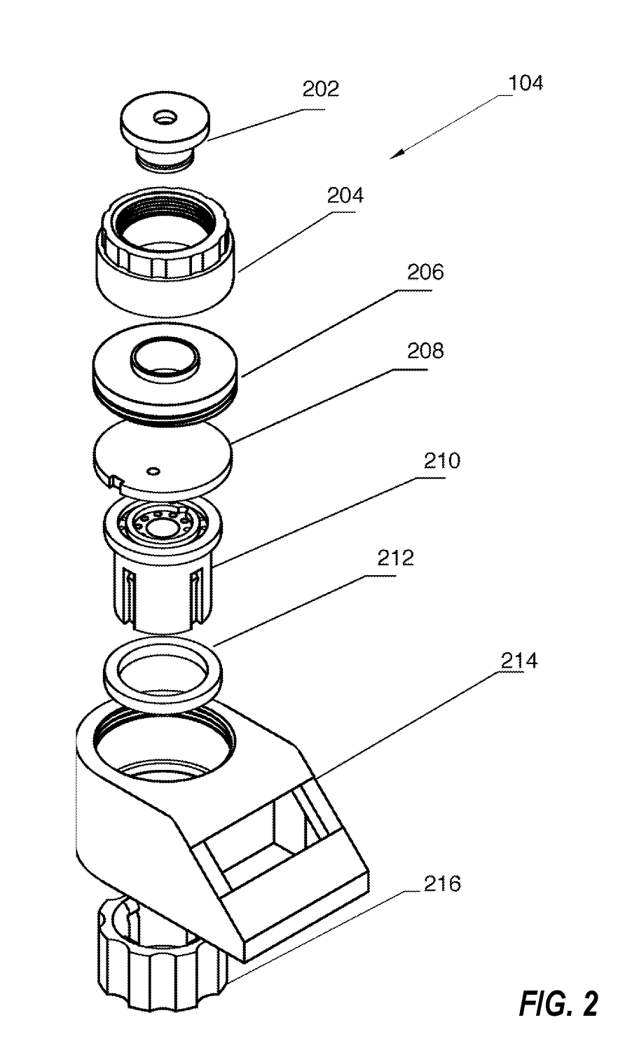

FIG. 2 illustrates components of the water monitoring and control device 104 from FIG. 1 that is configured in accordance with one aspect of the water monitoring system with adjustable aerator to implement a water-flow adjustment device with an adjustable water dispensing device. The water monitoring and control device 104 includes a rotator 202, an adapter 204, a snap on (adapter mount) 206, a selection disk 208, an aerator 210, an O-ring 212, a shell 214, and a finger grip 216.

Continuing to refer to FIG. 2, the rotator 202, also referred to as a faucet adapter retainer, is snapped into the snap on 206, securing the adapter 204 in place. The snap on 206 screws on to the shell 214 and the adapter 204 will screw onto a supply line such as the supply pipe 102 of FIG. 1. A gasket (not shown) may be used to prevent water leakage from the seal between the adapter 204 and the supply line. The shell 214 holds the selection disk 208, the aerator 210, and the O-ring 212. The selection disk 208 directs the water in a steady stream into the aerator 210, where the water flow is then altered. The O-ring 212 help prevent overflow leakage in the shell 214. Lastly, the water monitoring and control device 104 may be switched to the different settings described herein using the finger grip 216 that allows water flowing from the aerator 210 to be provided with different flow patterns.

In various aspects of the disclosed approach, the water monitoring and control device 104 may be adjusted to provide different amounts of water output. For example, if a person wants to wash their dishes by hand, the water monitoring and control device 104 may be adjusted to a first setting to dispense the largest amount of water that may be provided from the supply pipe 102, as supplied by the water monitoring and control device 104. Similarly, if the person is simply washing their hands, the water monitoring and control device 104 may be adjusted to a second setting that dispenses less water than the first setting.

In various aspects of the disclosed approach, the water monitoring and control device 104 may dispense water in a variety of flow patterns. For example, the water monitoring and control device 104 may provide a lighter, almost sprinkler-like flow pattern. The specific flow pattern of the water being dispensed may correspond to the flow setting of the water monitoring and control device 104. For example, the sprinkler-like flow pattern provided may be provided when the water monitoring and control device 104 is adjusted to the second setting that dispenses less water than the first setting.

Consequently, when the user wishes to use the water monitoring and control device 104, the user may easily select from several flow rate settings that will change the amount of water flow. Each flow rate setting may also affect a pattern of the water flow. The settings will range from a light, wide spray to a heavy, straight, concentrated stream for different tasks like hand and produce washing to dishwashing or filling a large pot, respectively. Thus, the user may easily select which setting is preferred once the water is running to obtain the optimal flow for what the user is doing. When the user is finished with using the sink, the water-saving faucet will reset to the lowest pressure after each use. This will ensure that users never use water at a higher rate than is needed, but will always be able to easily change flow as desired.

In one aspect of the disclosed approach, the water monitoring and control device 104 may also include one or more displays to provide a visual signal of which usage setting is in effect. For example, one or more LED lights may be used as the display and the user would be able to tell which setting is currently in use through the visual signal that would be visible through changing the color of the one or more LED lights, which in turn would change the color of the illumination of the water being dispensed. In other aspects of the disclosed approach, other types of displays, such as a liquid crystal display (LCD) display with numerical and/or graphical displays, audible, visual indicators (such as lights, color wheels), or other such systems known to those of ordinary skill in the art may be implemented in the water monitoring and control device 104.

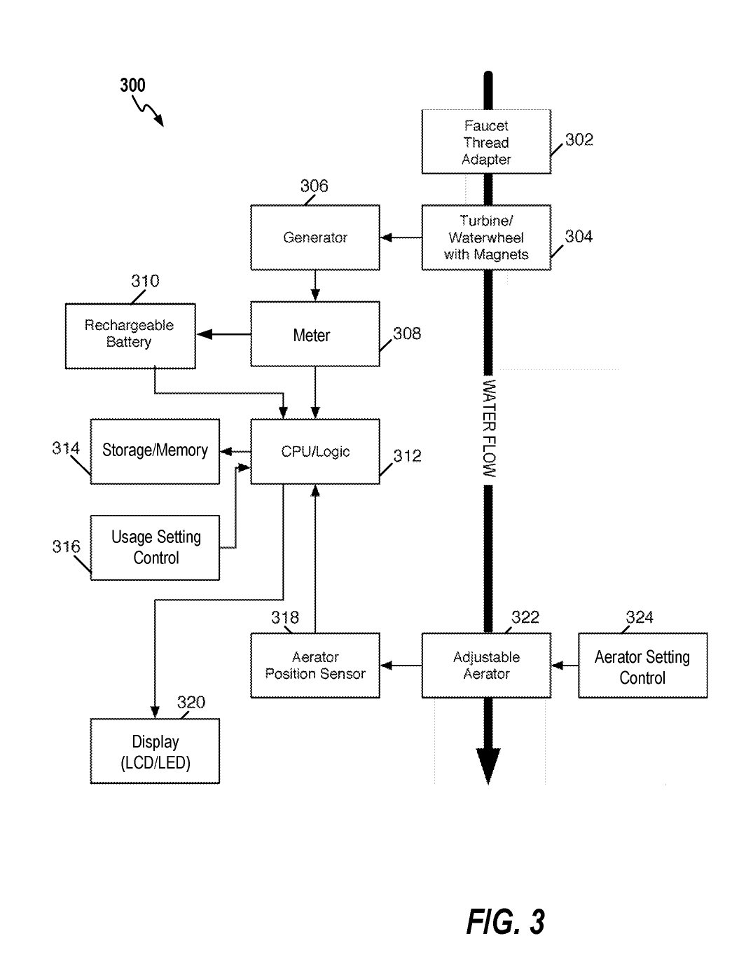

FIG. 3 illustrates the various functional blocks that may be used to implement the water monitoring and control device 104, including a faucet thread adapter 302 that may be used to attach the water monitoring and control device 104 to the supply line 102 of FIG. 1, from which water may flow through a turbine/waterwheel with magnets 304 to exit from an adjustable aerator 322.

In one aspect of the disclosure, a flow-rate of water dispensed from the water monitoring and control device 104 may be adjusted by the user to either be increased or decreased. This flow-rate may remain between each operation of the water monitoring and control device 104, or may be reset to a predetermined flow-rate. This predetermined flow-rate may be set by the user. In another aspect of the disclosure, the flow-rate may be reset to the lowest flow-rate setting after every operation of the water monitoring and control device 104.

In accordance with another aspect of the disclosure, the water monitoring and control device 104 may include a timer that helps to conserve water by providing an alert when water has been dispensing for a period of time. In other words, the water monitoring and control device 104 may include a shut-off timer to provide an alert if water has been running for longer than a prescribed period. The alert may be provided to the user as an audible beep or a visual signal. The alert may also be sent as a message to the user to alert the user that the water flow has exceeded the time allotted. For example, the user may receive a SMS message on a mobile device, or a notification in a smartphone app.

The turbine/waterwheel with magnets 304 is coupled to a generator 306, to which a meter 308 is attached to determine an amount of water being supplied. In one aspect of the disclosed approach, a CPU/logic module 312 may be used to determine the amount of water being supplied by measuring the electricity generated by the generator 306. The generator may generate electricity using current induction or could also use other generation technologies such as piezoelectric or charge pump technology as well as mechanical means.

A storage/memory 314 may be used by the CPU/logic module 312 to store programming and data. The data may include water usage data and how the water monitoring and control device 104 has been used. For example, the position of the adjustable aerator 322, as adjusted by an aerator setting control 324, such as a knob/button, may be sensed by an aerator position sensor 318. The position information may be stored along with how much water was dispensed by the water monitoring and control device 104 when the adjustable aerator 322 was in that position.

A display 320, which may include LEDs or LCDs, may be used to display information about the water monitoring and control device 104. A usage setting control 316, such as a knob/button, may be used to control the operation of the water monitoring and control device 104. For example, the usage setting control 316 may be coupled to the CPU/logic module 312 to control the operation of the water monitoring and control device 104.

The CPU/logic module 312 as well as other components of the water monitoring and control device 104 may be powered by a rechargeable battery 310. The rechargeable battery 310 may be recharged by the generator 306. In one aspect of the disclosure, the rechargeable battery 310 may be directly recharged by the generator 306. In another aspect of the disclosure, charging of the rechargeable battery 310 may be controlled by the CPU/logic module 312.

In one aspect of the disclosure, the water monitoring and control device 104 may include a transmitter to provide data or information using wireless communication. In another aspect of the disclosure, the water monitoring and control device 104 may include a receiver to receive data or information using wireless communication. For example, the water monitoring and control device 104 may be able to communicate with other devices within the household, such as other water-saving faucets, in order to display the cumulative water usage in the house at any moment in time. The water monitoring and control device 104 may also communicate with a smartphone app made for both iOS and Android operating systems in order to send data to the user's smartphone. This will allow the user to become aware of the amount of water being used in their house by checking the app.

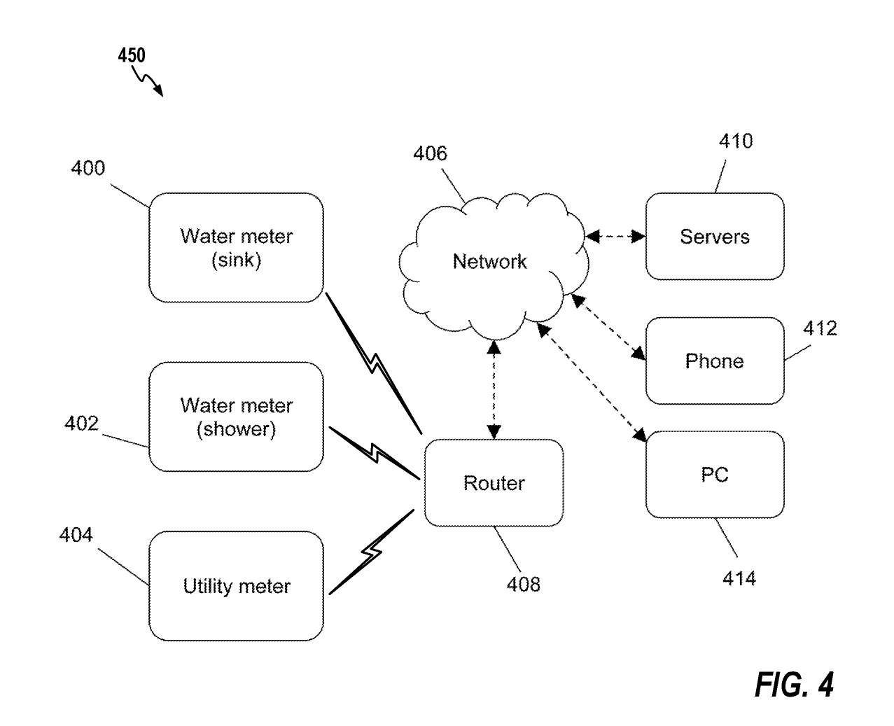

In one aspect of the disclosure, the water monitoring and control device 104 may communicate with other devices through the use of a network, such as through a wireless network. A scenario 450 of wireless network connectivity is shown in FIG. 4., where the water monitoring and control device 104 is represented as a water meter (sink) 400, which connects to the wireless network through a router 408. The router 408 transmits data received from the water meter (sink) 400 to a server 410, a phone 412, and a personal computer (PC) 414. Thus, the water meter (sink) 400 may connect to the router 408 and accesses the network 406 to transmit data to the server 410, the phone 412, or the PC 414. The water meter (sink) 400 may send or receive data through the server 410 for analysis, storage, reporting. A water meter (shower) 402 or a utility meter 404 may also connect to the router 408 to access the network 406. The data from the water meter (shower) 402 and the utility meter 404 may also send data transmissions through the router 408 to the server 410, from which the server 410 may analyze, store and report all data.

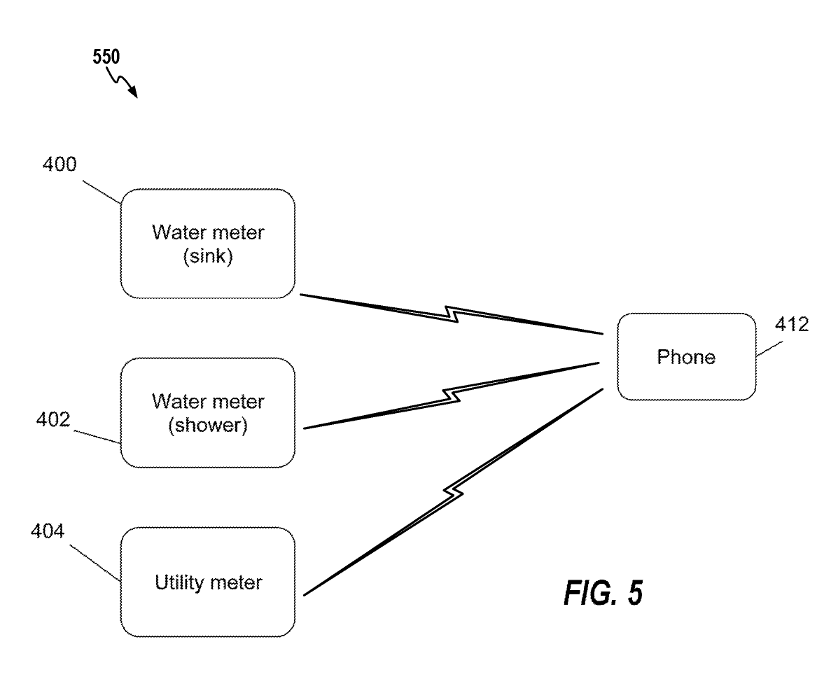

The water meter (sink) 400, the water meter (shower) 402, and the utility meter 404 may be direct connected to the phone 412 for communication. An example of this direct connectivity scenario 550 is shown in FIG. 5.

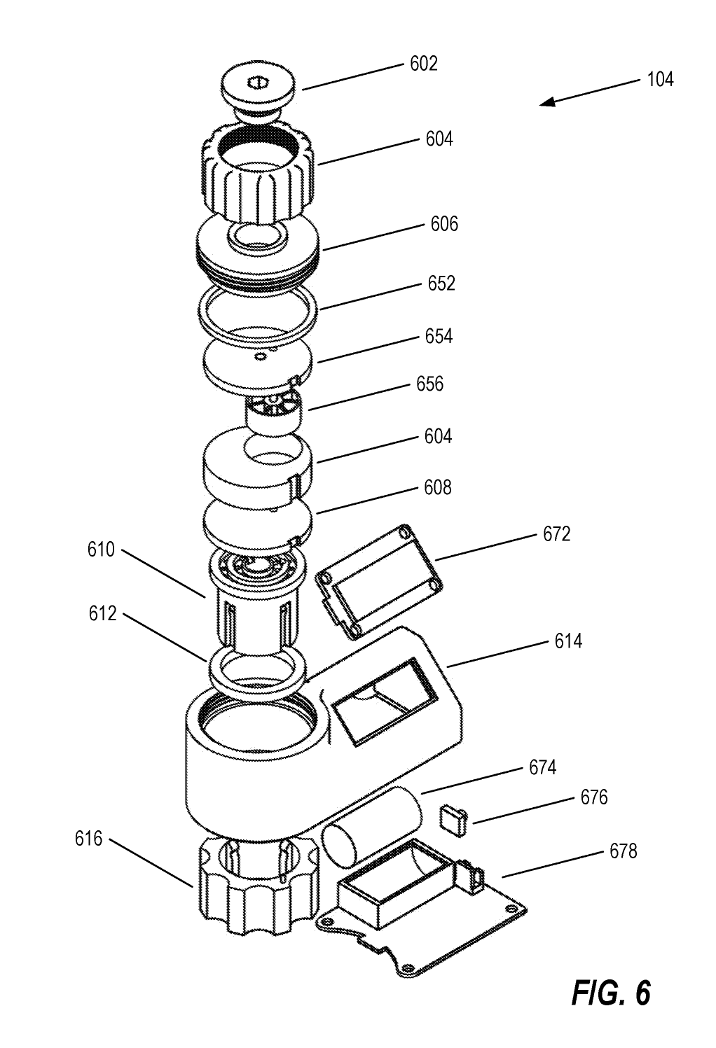

FIG. 6 illustrates components of the water monitoring and control device 104 from FIG. 1 that is configured in accordance with another aspect of the water monitoring system with adjustable aerator, which includes a rotator 602, an adapter 604, a snap on (adapter mount) 606, a selection disk 608, an aerator 610, an O-ring 612, a shell 614, and a finger grip 616. FIG. 6 also illustrates an O-ring 652, a flow director 654, a turbine 656, and turbine retainer 658 to provide an example of the turbine mechanism that may be used in the water monitoring and control device 104. Moreover, FIG. 6 illustrates a display 672, a battery 674, a switch 676, and a housing cover 678 as an example of the electronics that may be used in the water monitoring and control device 104. It should be noted that these should be taken as examples and nothing in the description should limit the scope of the claims, other than the claim language, as to what may be used to implement the various aspects of the disclosure.

The rotator 602, also referred to as a faucet adapter retainer, is snapped into the snap on 606, securing the adapter 604 in place. The snap on 606 screws on to the shell 614. The adaptor 604 includes threads that may be screwed onto threads that are on a supply line such as the supply pipe 102 of FIG. 1. Thus, to secure the water monitoring and control device 104 to the supply pipe 102, the adapter 604 may be screwed onto the supply pipe 102. A gasket (not shown) may be used to prevent water leakage from the seal between the adapter 604 and the supply line.

The O-ring 652 help prevent leakage from the shell 614 as water enters into the shell 614 and is directed by the flow director 654 to turn the turbine 656. The turbine 656 may be secured by holes in the flow director 654 and the seletion disk 608 while contained in the turbine retainer 658. The shell 614 also holds the selection disk 608, the aerator 610, and the O-ring 612. The selection disk 608 directs the water in a steady stream into the aerator 610, where the pattern and/or amount of water flow is then altered. The O-ring 612 help prevent overflow leakage in the shell 614.

In addition to containing the various mechanisms used to control water flow, the shell 614 also houses the display 672, the battery 674, and the switch 676, as enclosed by the housing cover 678. The display 672 includes a circuit board on which the CPU/logic module discussed herein may be integrated. As discussed, the turbine may contain magnets to cause an induction of current in a coil, which acts as the generator of electricty. This induced current may be used to recharge the battery 674 that powers the display 672. The switch 678 may be used to interact with the display 672 and, in general the CPU/logic module, to control the water monitoring and control device 104.

To provide manual control by the user, the water monitoring and control device 104 may be switched to the different settings described herein using the finger grip 616 that allows water flowing from the aerator 610 to be provided with different flow patterns and/or rates.

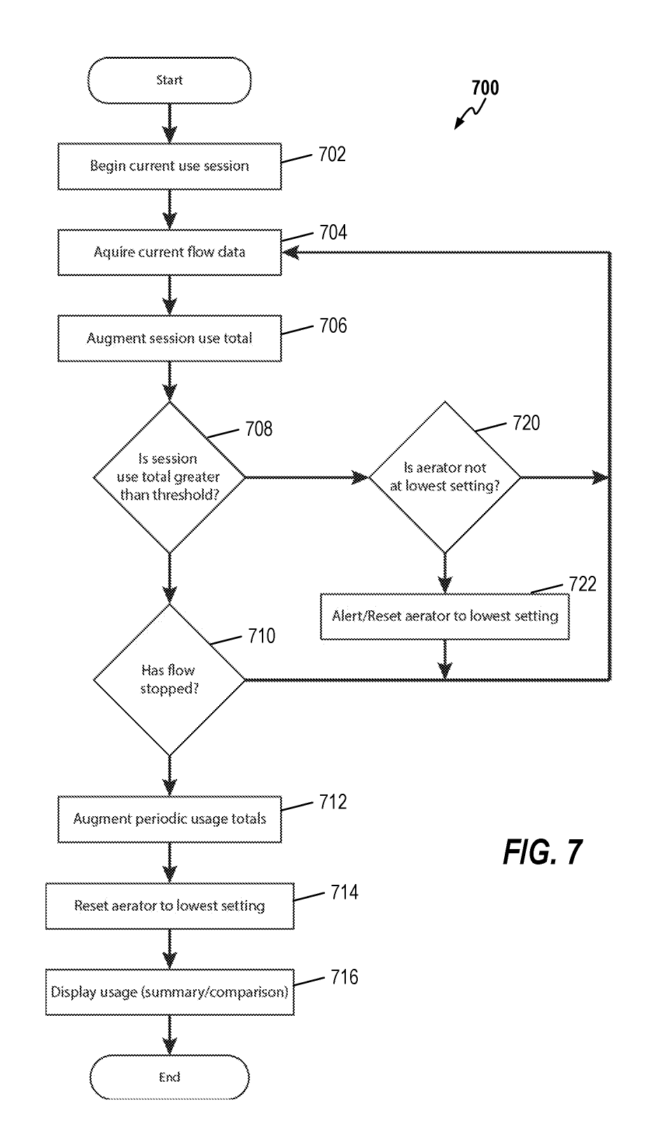

FIG. 7 illustrates a process 700 by which various aspects of the operation of the the water monitoring and control device 104 may be described where, at 702, a current use session may begin when the user turns on the faucet and supplies the water monitoring and control device 104 with water.

At 704, the water monitoring and control device 104 acquires current flow data, which may include a rate of water flow, or a flow of water over a period of time.

At 706, where the water continues to flow, a total session water use total may be augmented, or updated, with the total amount used in the session.

At 708, it is determined if the current session water use is greater than a threshold, which may be set by the user or a default amount. For example, the threshold may be one gallon, one liter, or any amount. If the total amount of water used so far in this session exceeds the threshold, then ooperation may continue to 720. Otherwise, operation continues with 710.

At 710, it is determined if the flow of water has been stopped. If so, then operation continues with 712. Otherwise, operation returns to 704, where the current flow data is collected again, as described above.

At 712, the total water use for this session augments, or modifies, the period usage total so that the period usage total is updated. The period usage total may include usage totals for more than one span of time, including hours, days, weeks, months, etc.

At 714, the aerator may be reset to its lowest flow setting. Thus, the user does not have to remember to try and conserve water by using the lowest setting because it will automatically be selected by the water monitoring and control device 104 after each use. The user may choose to disable this feature.

At 716, the water monitoring and control device 104 may display usage information about the current session, including usage summary and a comparison between the amount of water used with a baseline.

In one aspect of the disclosure, a faucet equipped with the water monitoring and control device 104 allows a user to compare the user's water use to one or more baselines, which, for example, may be recommended usage totals or other appropriate metrics. Measurements and comparisons may be performed over one or more use types, and one or more time periods. For example, the baseline may be a per-session, daily, weekly, or monthly amount. In addition, the baseline may be linked to the aerator setting or user behavior a inferred algorithmically or indicated directly by the user. The units of measurement may be selected by the user. For example, measurements may be expressed in such units as liters, gallons or cups. The baselines may also be preset or adjusted by the user to account for various conservation targets and usage scenarios. For example, baselines may be adjusted based on the number of persons expected to be using the device in the location where it is installed such as the count of members of a household or guests staying in a hotel room. Adjustment of baselines may be accomplished through direct interaction with the device through a button such as the switch 676 described above, touch screen in the display 672, or other such mechanism or through communication with another device either directly or via a network as disclosed in FIG. 5 and FIG. 4 respectively. Furthermore, such adjustment may be controlled by the end user or by another entity. For example, a water utility or building manager may establish baseline values for the devices at installation or afterwards.

Returning to FIG. 7 at 720, if the current water use is greater than the threshold, it is determined is the aerator at the lowest setting. If the aerator is at the lowest setting, then operation continues with 704. Otherwise, operation continues with 722.

At 722, where the current water use exceeds the threshold, the user may be notified, such as by an alert on the display or an audible alarm. In addition, the aerator may be reset to the lowest setting to limit the amount of water being dispensed in case the user has forgotten to shut off the faucet, thus also limiting the amount of water being wasted. For example, if the user starts to fill a pot on the full flow setting but leaves the kitchen, the water monitoring and control device 104 will be able to alert the user when the threshold has been exceeded by the amount of water used in the current session. The notification may also be useful to remind the user how much water has been dispensed in the current session, such as when the user is washing dishes and leaves the water running

Those of skill would further appreciate that any of the various illustrative logical blocks, modules, processors, means, circuits, and algorithm steps described in connection with various aspects of the water monitoring system with adjustable aerator disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”). The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes (e.g., executable by at least one computer) relating to one or more of the aspects of the disclosure. In some aspects, a computer program product may comprise packaging materials.

Although the various aspects of the water monitoring system with adjustable aerator disclosed herein has been described in detail in connection with the various examples shown in the figures, it is to be understood by those skilled in the art that other embodiments may provide the same results. Variations and modifications to the provided examples should be discernable to those skilled in the art and should be considered to fall within the scope of any claims recited herein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A water-flow adjustment device comprising:
a first end configured to be attached to a pipe providing water;
a second end comprising an adjustable water dispensing device comprising flow rate settings configured to allow a flow rate of water dispensed through the second end to be changed;
a water usage monitor configured to measure an amount of water received from the first end; and
a display configured to provide information about of how much water is dispensed through the second end based on the amount of water received from the first end, as measured by the water usage monitor, wherein the display is further configured to provide a notification based on: (a) the flow rate settings of the adjustable water dispensing device, and (b) a comparison between the amount of water received from the first end and a predetermined limit.

2. The water-flow adjustment device of claim 1, wherein the flow rate settings comprise a default flow rate and the water-flow adjustment device is configured to reset the adjustable water dispensing device to the default flow.

3. The water-flow adjustment device of claim 1, wherein the adjustable water dispensing device is reset to the default flow rate based on the amount of water received from the first end.

4. The water-flow adjustment device of claim 3, wherein the adjustable water dispensing device is reset to the default flow rate when no water is received from the first end for a predetermined period of time.

5. The water-flow adjustment device of claim 1, wherein the pipe providing water comprises a threaded end, and the water-flow adjustment device further comprises an adapter configured attach the first end to a threaded end of the pipe providing water.

6. The water-flow adjustment device of claim 1, wherein the adjustable water dispensing device further comprises a water shaping device configured to allow different flow patterns.

7. The water-flow adjustment device of claim 6, wherein the adjustable water dispensing device comprises an aerator.

8. The water-flow adjustment device of claim 1, further comprising:
a turbine configured to be turned based on the amount of water received from the first end, wherein the water usage monitor comprises a sensor configured to determine the amount of water dispensed from the second end based on the turbine being turned.

9. The water-flow adjustment device of claim 8, further comprising:
a generator coupled to the turbine and configured to be operated based on the turbine being turned.

10. The water-flow adjustment device of claim 9, wherein the sensor comprises a voltage detector configured to measure a voltage generated from the generator based on the turbine being turned.

11. The water-flow adjustment device of claim 9, further comprising:
a rechargeable battery configured to be charged by power received from the generator based on the turbine being turned.

12. The water-flow adjustment device of claim 1, wherein the display is further configured to display a baseline amount by which the amount of water received from the first end may be compared.

13. The water-flow adjustment device of claim 1, wherein the baseline amount represents water consumption over a period of time.

14. The water-flow adjustment device of claim 1, further comprising:
a valve configured to control water received by the first end from the pipe providing water.

15. The water-flow adjustment device of claim 1, further comprising:
a radio transmitter configured to transmit information provided by the water usage monitor.

16. The water-flow adjustment device of claim 1, further comprising:
a radio receiver configured to receive signals configured to operate the adjustable water dispensing device.

17. The water-flow adjustment device of claim 1, further comprising:
a network transceiver configured to couple the water-flow adjustment device to other devices having water usage monitoring features.
